(19) United States
(12) Patent Application Publication
(10) Pub. No.: US 2010/0275448 A1
(43) Pub. Date: Nov. 4, 2010

(54) Pneumatic saw power transmission structure

(75) Inventors: Yung-Yung Sun, Dali City (TW); Chuan-Ching Cheng, Taiping City (TW)

Correspondence Address: Wang Law Firm, Inc., 4989 Peachtree Parkway,, Suite 200, Norcross, GA, 30092, US

(73) Assignee: STORM PNEUMTIC TOOL CO., LTD, Dali City (TW)

(21) Appl. No.: 12/434,659

(22) Filed: May 3, 2009

(51) Int. Cl. B23D 51/18; B25F 5/00

(52) U.S. Cl. 30/277.4

(57) ABSTRACT

A pneumatic saw power transmission structure includes a main body, a first transmission module and a second transmission module installed adjacent with each other in a containing groove of the main body. The second transmission module includes a position limit device fixed at the main body for limiting the second transmission module in the containing groove of the main body to constitute the transmission structure of the present invention.

### BACKGROUND OF THE INVENTION

1. Field of the Invention

The present invention relates to a pneumatic saw power transmission structure, in particular to a positioning transmission module structure having a position limit device.

2. Description of the Related Art

With reference to FIG. 7 for a conventional pneumatic saw power transmission structure, an air motor installed in a main body 90 drives a first transmission module 91 to rotate, and the first transmission module 91 drives a second transmission module 92 to engage and rotate a gear 911 and a gear 921 installed between the first transmission module 91 and the second transmission module 92, and the second transmission module 92 includes a cam 922, such that the second transmission module 92 is rotated and the cam 922 is driven to move the saw blade back and forth.

Since the gears 911, 921 are engaged and rotated between the first transmission module 91 and the second transmission module 92, and the interval between the transmission modules 91, 92 is very short, and the main body of the pneumatic saw has a limited space that cannot extend the transmission distance between the gears 911, 921, and the cam 922 installed at an end of the second transmission module 92 cannot be sheathed to the bearing, therefore the first transmission module 91 and the second transmission module 92 cannot be positioned at both ends of the bearing respectively. Although the bearing at an end can be positioned, yet the positioning effect is poor, and both transmission modules 91 and 92 may be worn out or damaged easily due to the friction produced between the transmission modules 91, 92 with the main body 90 and caused by a deviation occurred during an actual operation.

Therefore, an important point of the present invention is to overcome the aforementioned shortcomings of the prior art.

### SUMMARY OF THE INVENTION

It is a primary objective of the present invention to overcome the shortcomings of the prior art by providing a pneumatic saw power transmission structure to achieve the effect of positioning the first axle and the second axle securely to avoid the axles from being worn out or producing noises caused by the deviation.

To achieve the foregoing objective, tile present invention provides a pneumatic saw power transmission structure comprising:

a main body, having an air motor installed at an end of the main body, a connecting portion disposed at another end of the main body and axially slidable into the main body, and a containing groove disposed between the air motor and the connecting portion, and an end of the connecting portion being extended into the containing groove, and another end of the connection portion being secured with a saw blade;

a first transmission module, installed in the containing groove of the main body and proximate to a side of the air motor, and the first transmission module having a first axle driven by the air motor, and a first wheel rotated synchronously with the axle of the first transmission module, and a bearing being installed individually at both ends of the first axle;

a second transmission module, installed in the containing groove of the main body and proximate to a side of the connecting portion, and the second transmission module having a second axle, and the second axle having a disc portion, and a second wheel being installed coaxially at an end of a disc portion, and the second wheel being driven by the first wheel to rotate through a transmission belt, and a bearing being installed at an end of the second wheel at the second axle, and the disc portion having a cam portion for driving the saw blade to move back and forth, and the cam portion having a circular column coaxially disposed at the second wheel, and a protruding column being disposed at a distal surface of the circular column other than the central position or the circular column, and a circular wheel being pivotally installed at the protruding column;

a pillow block bearing, limited in the containing groove of the second transmission module, and including a ring installed around a roller pin and sheathed to the circular column, a position limit device sheathed onto the ring, and the position limit device being fixed at the main body, and a circular wall portion being extended from the position limit device, and a stop wall extended from the top of the circular wall portion, and the ring being limited on the circular column by the stop wall of the position limit device and the disc portion, and the roller pin of the ring abutting an external circular wall of the circular column and an internal circular wall of the circular wall portion;

a guide rail, installed in the containing groove of the main body and between the second transmission module and the connecting portion;

a transmission device, for driving the connecting portion to slide axially, and an end of the transmission device being fixed at the connecting portion that is extended out from the containing groove, and an end of the transmission device having a rail rest disposed across the guide rail, and another end of the transmission device having a slot for sheathing the wheel.

The above and other objects, features and advantages of the present invention will become apparent from the following detailed description taken with the accompanying drawing.

Only some embodiments of the present invention have been illustrated in the drawings, but it should be pointed out that many other modifications are conceivable within the scope of the following claims

### BRIEF DESCRIPTION OF THE DRAWINGS

FIG. 1 is a perspective view of a transmission structure of the present invention;

FIG. 2 is an exploded view of a transmission structure of the present invention;

FIG. 3 is a cross-sectional top view of a transmission structure of the present invention;

FIG. 4 is a cross-sectional side view of a transmission structure of the present invention;

FIG. 5 is a partial enlarged view of a cross-section as depicted in FIG. 4;

FIG. 6 is a schematic view of a transmission device sliding on a guide rail; and

FIG. 7 is a cross-sectional view of a conventional pneumatic saw transmission structure.

### DETAILED DESCRIPTION OF THE PREFERRED EMBODIMENTS

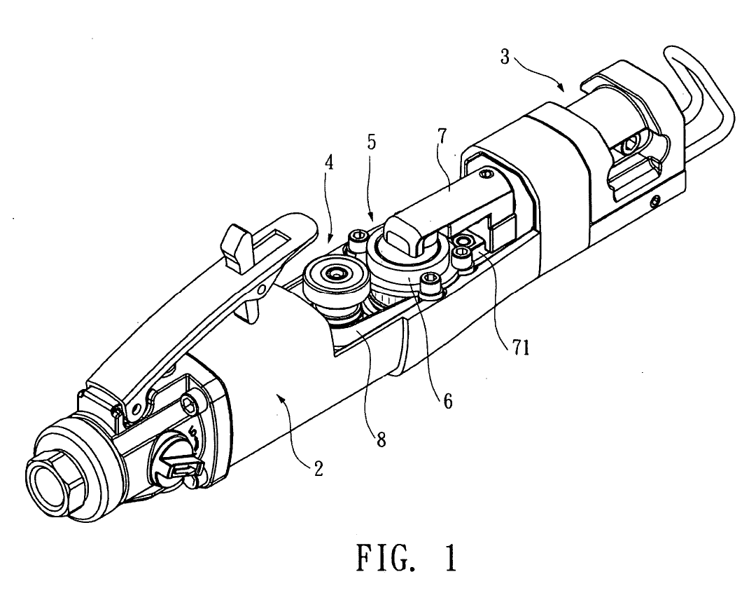

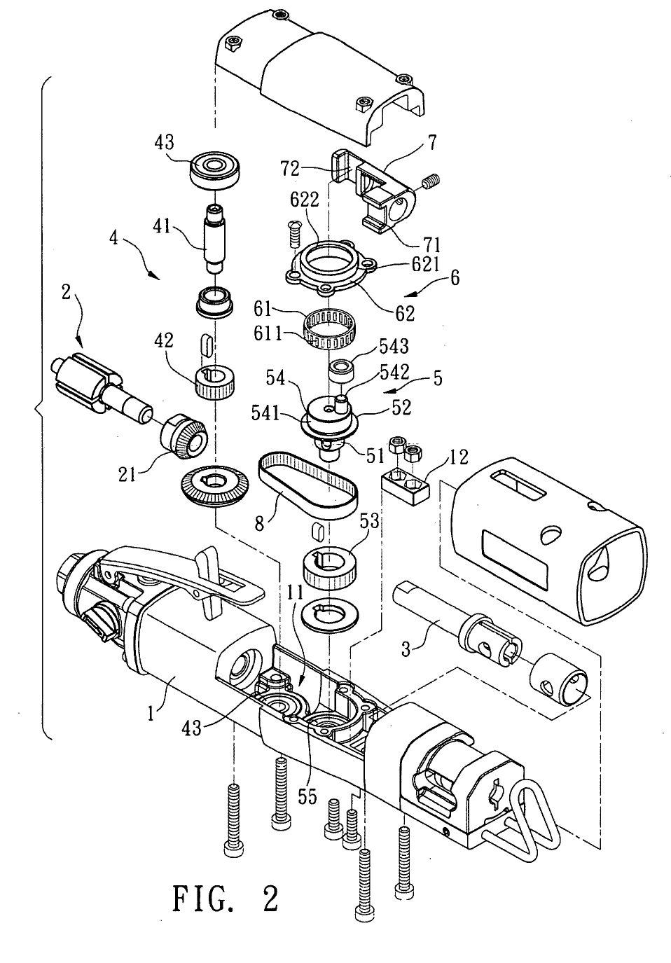

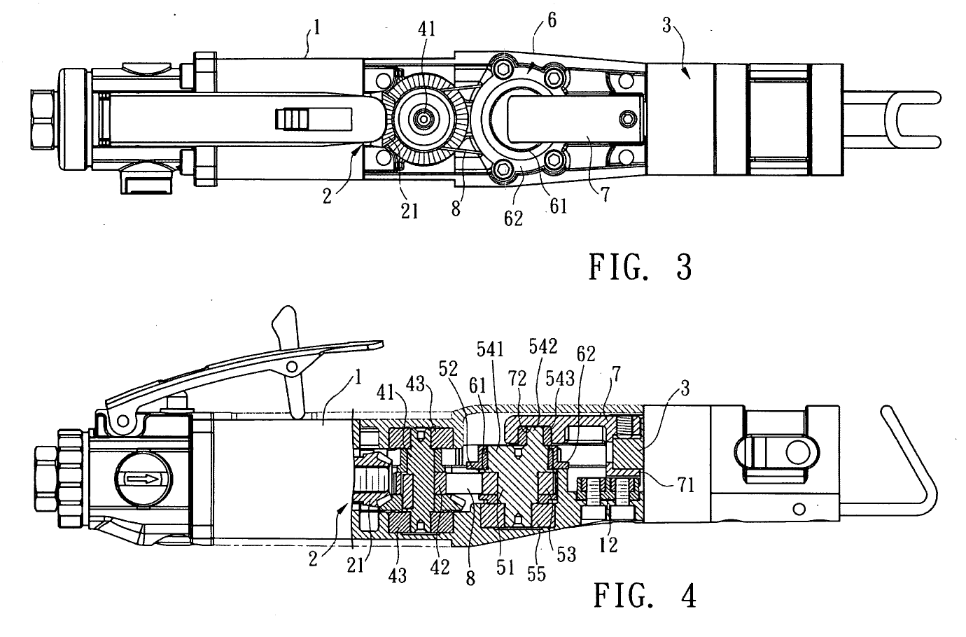

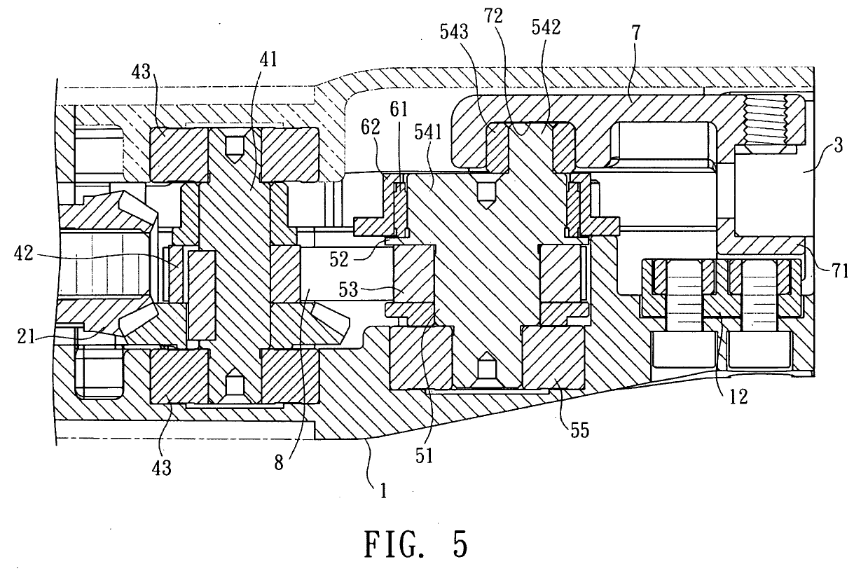

With reference to FIGS. 1 to 5 for a preferred embodiment of the present invention, the embodiment is used for illustrating the present invention only, but not intended for limiting the scope of the invention.

This preferred embodiment provides a pneumatic saw power transmission structure, comprising:

a main body 1, having an air motor 2 installed at an end of the main body 1, a connecting portion 3 disposed at another end of the main body 1 and slidable axially in the main body 1, and a containing groove 11 disposed between the air motor 2 and the connecting portion 3, and an end of the connecting portion 3 being extended out from the containing groove 11, and another end of the connecting portion being secured with a saw blade (not shown in the figure);

a first transmission module 4, installed in the containing groove 11 of the main body 1 and proximate to a side of the air motor 2, and the first transmission module 4 having a first axle 41, and the first transmission module 4 of this preferred embodiment being driven by the air motor 2 to drive an umbrella gear 21, and the first axle 41 having a first wheel 42 installed thereon, and the first wheel 42 being rotated synchronously with the first axle 41, and a bearing 43 being installed individually at both ends of the first axle;

a second transmission module 5, installed in the containing groove 11 of the main body 1 and proximate to a side of the connecting portion 3, and the second transmission module 5 having a second axle 51, and the second axle 51 having a disc portion 52, and the second axle 51 having a second wheel 53 coaxially fixed at an end of the disc portion 52, and the second wheel 53 being driven by the first wheel 42 to rotate through a transmission belt 8, and the transmission belt 8 of this preferred embodiment being a timing belt, and the second axle 51 having a bearing 55 installed at an end of the second wheel 53, and a cam portion 54 disposed at another end of the disc portion 52, and the cam portion 54 driving the saw blade to move back and forth, and the cam portion 54 having a circular column 541 coaxially installed with the second wheel 53, and the circular column 541 having a protruding column 542 disposed at an end surface other than the central position of the circular column 541, and a circular wheel 543 being pivotally installed at the protruding column;

a pillow block bearing 6, for limiting the second transmission module in the containing groove, and the pillow block bearing 6 including a ring 61 installed around a roller pin 611 and sheathed onto the circular column 541, and a position limit device 62 being sheathed onto the ring 61, and the position limit device 62 being fixed to the main body 1 by screws, and a circular wall portion 621 being extended from the position limit device 62, and a stop wall 622 being extended out from the top of the circular wall portion 621, and the ring 61 being limited onto the circular column 541 by the stop wall 622 of the position limit device 62 and the disc portion 52, and the roller pin 611 of the ring 61 abutting an external circular wall of the circular column 541 and an internal circular wall of the circular wall portion 621;

a guide rail 12, installed in the containing groove 11 of the main body 1 and between the second transmission module 5 and the connecting portion 3; and

a transmission device 7, for driving the connecting portion 3 to slide axially, and having the connecting portion 3 fixed at an end of the transmission device 7 to be extended out from an end of the containing groove 11, and the end of the transmission device 7 having a rail rest 71 disposed across the guide rail 12, and another end of the transmission device 7 having a slot 72 sheathed onto the wheel 543.

From the aforementioned structure of the present invention, the transmission belt 8 is transmitted between the first transmission module 4 and the second transmission module 5 to elongate the interval between the first axle 41 and the second axle 51, such that each of the ends of the first axle 41 can install a bearing 43, and the second axle 51 at an end can be sheathed onto the circular column 541 by the pillow block bearing 6 to achieve the positioning effect, and the wheel 543 is protruded out from the pillow block bearing 6 and provided for sheathing the transmission device 7. Therefore, the second axle 51 not just achieves the positioning effect by installing a bearing individually at both ends of the bearing only, but also successfully drives the transmission device 7 by the cam portion 54, so that the connecting portion 3 can drive the saw blade to move back and forth.

From the description above, the advantage of the present invention resides on that the interval between the first axle 41 and the second axle 51 in the main body is elongated, and thus the two axles can be positioned by the bearings at both ends, so as to avoid worn-outs and noises produced by the deviation occurred while the first axle 41 and the second axle 51 are being rotated.

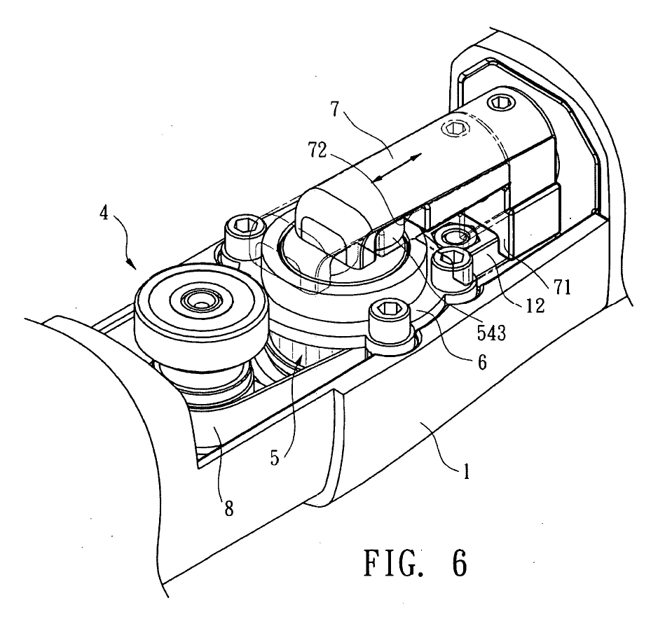

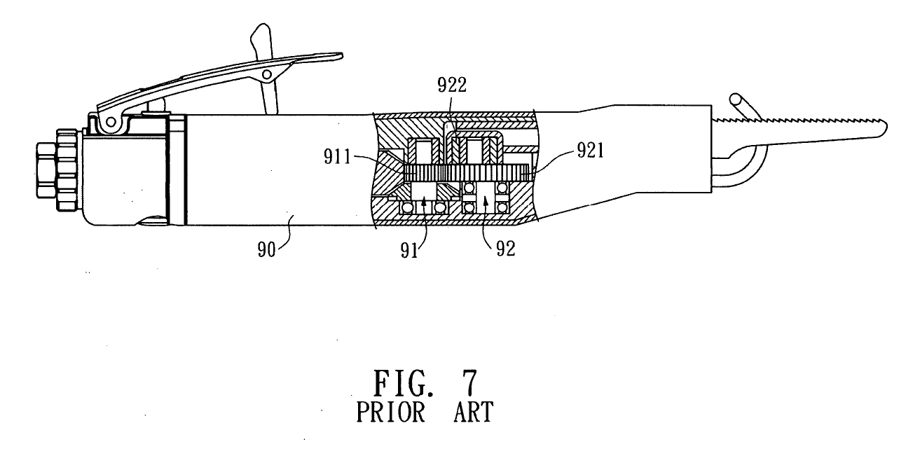

To avoid a turnover at the side when the transmission device 7 is operated at the cam portion 54, the present invention includes a guide rail 12 installed in the containing groove 11 of the main body 1 and provided for installing the rail rest 71 of the transmission device 7. If the transmission device 7 is driven at the cam portion 54 as shown in FIG. 6, the rail rest 71 and the guide rail 12 slide with respect to each other to provide a guiding effect, so as to prevent the transmission device 7 from being turned over in the transmission process.

In summation of the description above, the present invention improves over the prior art and complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A pneumatic saw power transmission structure, comprising:
a main body, having an air motor installed at an end of the main body, a connecting portion disposed at another end of the main body and axially slidable into the main body, and a containing groove disposed between the air motor and the connecting portion, and an end of the connecting portion being extended into the containing groove, and another end of the connection portion being secured with a saw blade;
a first transmission module, installed in the containing groove of the main body and proximate to a side of the air motor, and the first transmission module having a first axle driven by the air motor, and a first wheel synchronously rotated with the first axle of the first transmission module, and a bearing being installed individually at both ends of the first axle;
a second transmission module, installed in the containing groove of the main body and proximate to a side of the connecting portion, and the second transmission module having a second axle, and the second axle having a disc portion, and a second wheel being installed coaxially at an end of the disc portion, and the second wheel being driven by the first wheel to rotate through a transmission belt, and a bearing being installed at an end of the second wheel at the second axle, and the disc portion having a cam portion for driving the saw blade to move back and forth, and the cam portion having a circular column coaxially disposed at the second wheel, and a protruding column being disposed at a distal surface of tile circular column other than the central position of the circular column, and a circular wheel being pivotally installed at the protruding column;
a pillow block bearing, limited in the containing groove of the second transmission module, and including a ring installed around a roller pin and sheathed to the circular column, a position limit device sheathed onto the ring, and the position limit device being fixed at the main body, and a circular wall portion being extended from the position limit device, and a stop wall extended from the top of the circular wall portion, and the ring being limited on the circular column by the stop wall of the position limit device and the disc portion, and the roller pin of the ring abutting an external circular wall of the circular column and an internal circular wall of the circular wall portion;
a guide rail, installed in the containing groove of the main body and between the second transmission module and the connecting portion; and
a transmission device, for driving the connecting portion to slide axially, and an end of the transmission device being fixed at the connecting portion that is extended out from the containing groove, and the end of the transmission device having a rail rest disposed across the guide rail, and another end of the transmission device having a slot, for sheathing to the wheel.

2. The pneumatic saw power transmission structure of claim 1, wherein the transmission belt is a timing belt.
